(19) United States
(12) Patent Application Publication
(10) Pub. No.: US 2006/0071936 A1
(43) Pub. Date: Apr. 6, 2006

(54) Method of improving the perceptual contrast of displayed images

(76) Inventors: Evgeniy Leyvi, Riverdale, NY (US); Sandeep M Dalal, Cortlandt Manor, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/537,009

(22) PCT Filed: Nov. 12, 2003
(86) PCT No.: PCT/IB03/05122

§ 371 Date: May 25, 2005

Related U.S. Application Data
(60) Provisional application No. 60/429,707, filed on Nov. 27, 2002.

(51) Int. Cl. G09G 5/02

(52) U.S. Cl. 345/589

(57) ABSTRACT

A method of processing an image comprising: measuring a set of pixel dependent attributes for a pixelated video frame, each pixel of the frame having a gray level, each gray level associated with a brightness level; and in response to each and every pixel dependent attribute of the set of pixel dependent attributes meeting a corresponding criteria, decreasing the overall brightness of the video frame in accordance with a global brightness signal and increasing the brightness of the gray level of each pixel of the video frame in accordance with a local brightness control signal, the amount a particular gray level brightness is increased being dependent upon the particular gray level and a function of the measured pixel dependent attributes.

The present invention relates to the field of image display systems; more specifically, it relates to a method and system for controlling the contrast of pixels in a displayed image.

Reflective and transmissive liquid crystal displays (LCDs) suffer from a lack of contrast when compared to cathode ray tube (CRT) and micro-mirror device (DMD) based display devices. For example, on existing reflective LCD projectors, dark regions of images appear as dark blue due to the fact that a perceivable quantity of light of mostly short wavelength is still reflected from the LCD pixel even with the pixel off. This results in reduced contrast in displayed images and unwanted coloration of dark areas.

Simple brightness modulation does not solve this problem because dark areas are boosted and bright areas are clipped resulting in a reduced contract image with loss of details in the bright areas. Simple contrast modulation does not solve this problem either, because, while dark regions are preserved, bright areas are altered leading to loss of detail again.

Therefore, the present invention provides for reflective and transmissive LCD systems that maintains image contrast while not introducing unwanted coloration.

Accordingly, a first aspect of the present invention is a method of processing an image comprising: measuring a set of pixel dependent attributes for a pixelated video frame, each pixel of the frame having a gray level, each gray level associated with a brightness level; and in response to each and every pixel dependent attribute of the set of pixel dependent attributes meeting a corresponding criteria, decreasing the overall brightness of the video frame in accordance with a global brightness signal and increasing the brightness of the gray level of each pixel of the video frame in accordance with a local brightness control signal, the amount a particular gray level brightness is increased being dependent upon the particular gray level and a function of the measured pixel dependent attributes.

A second aspect of the present invention is an apparatus for processing an image comprising: means for measuring a set of pixel dependent attributes on a pixelated video frame, each pixel of the frame having a gray level, each gray level associated with a brightness level; means for decreasing the overall brightness of the video frame by an amount in response to each and every pixel dependent attribute of the set pixel dependent attributes meeting a corresponding criteria; and means for increasing the brightness of the gray level of each pixel of the frame by different amounts in response to each and every response to each and every pixel dependent attribute of the set pixel dependent attributes meeting a corresponding criteria, the amount a particular gray level brightness is increased being dependent upon the particular gray level and a function of the measured pixel attributes.

A third aspect of the present invention is a system for projecting an image onto a display screen comprising: a light source; a light-attenuating device for attenuating light emitted from the light source, the light-attenuating device responsive to a global brightness control signal; a reflective electro-optical modulating device onto to which exit light from the light-attenuating device is projected, the electro-optical modulating responsive to a local brightness adjusted video signal; means for projecting light reflected from the electro-optical modulating device onto the display screen; a histogram analyzer adapted to receive a pixelated video frame of the image and to output the global brightness control signal, the global brightness control signal reducing the brightness of every pixel in the frame, adapted to output the local brightness adjusted video signal, the local brightness adjusted video signal increasing selected gray-levels of the pixelated frame and the histogram analyzer adapted to analyze the pixels of the frame, the global brightness control signal and the local brightness adjusted video signal based on the analysis of the pixels.

The features of the invention are set forth in the appended claims. The invention itself, however, will be best understood by reference to the following detailed description of an illustrative embodiment when read in conjunction with the accompanying drawings, wherein:

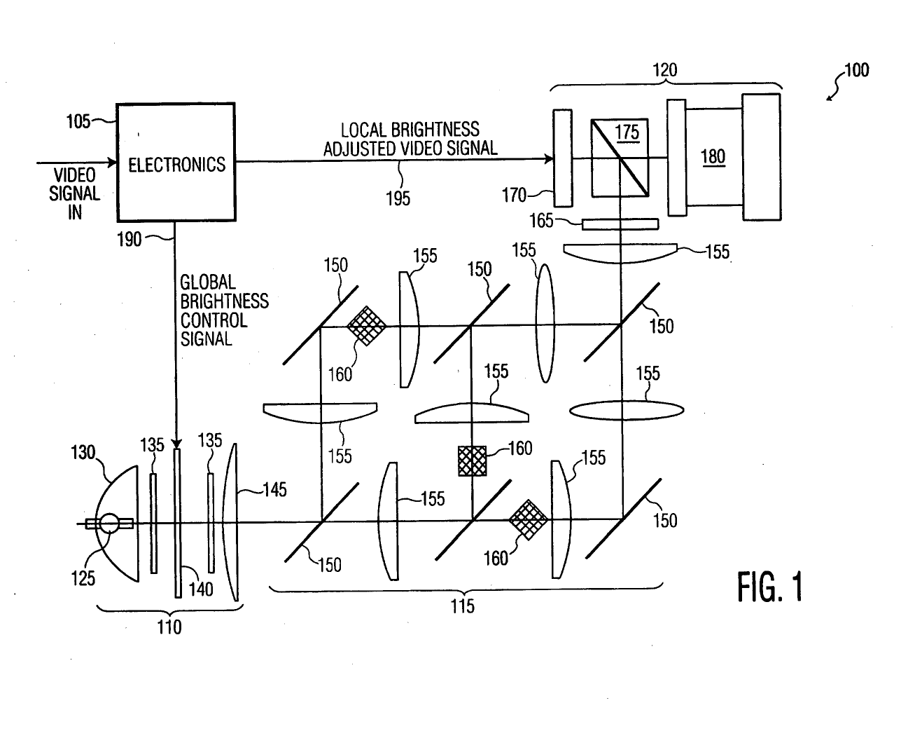

FIG. 1 is a schematic diagram of an exemplary display system, according to embodiments of the present invention;

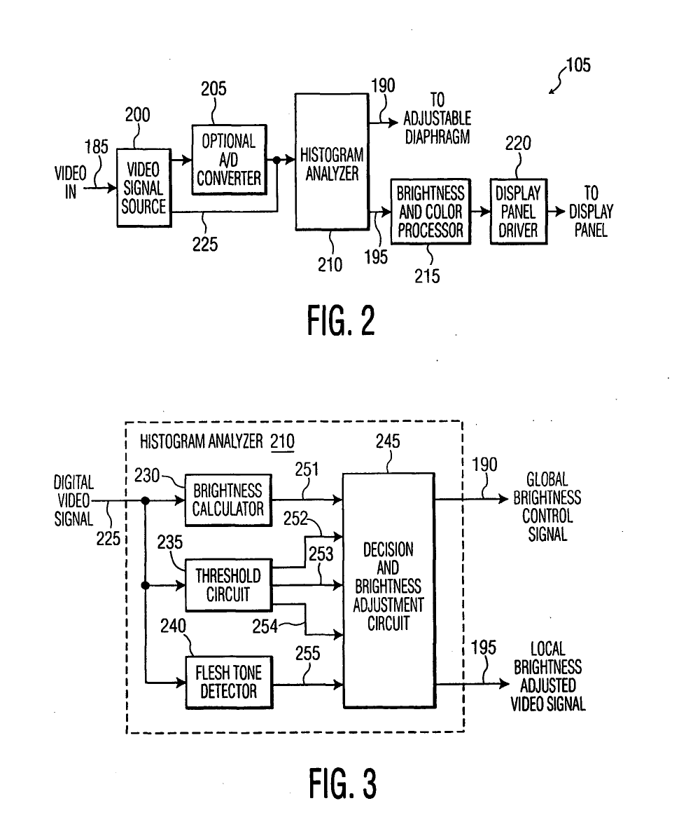

FIG. 2 is a block schematic diagram of the electronic components of the display system of FIG. 1, according to embodiments the present invention;

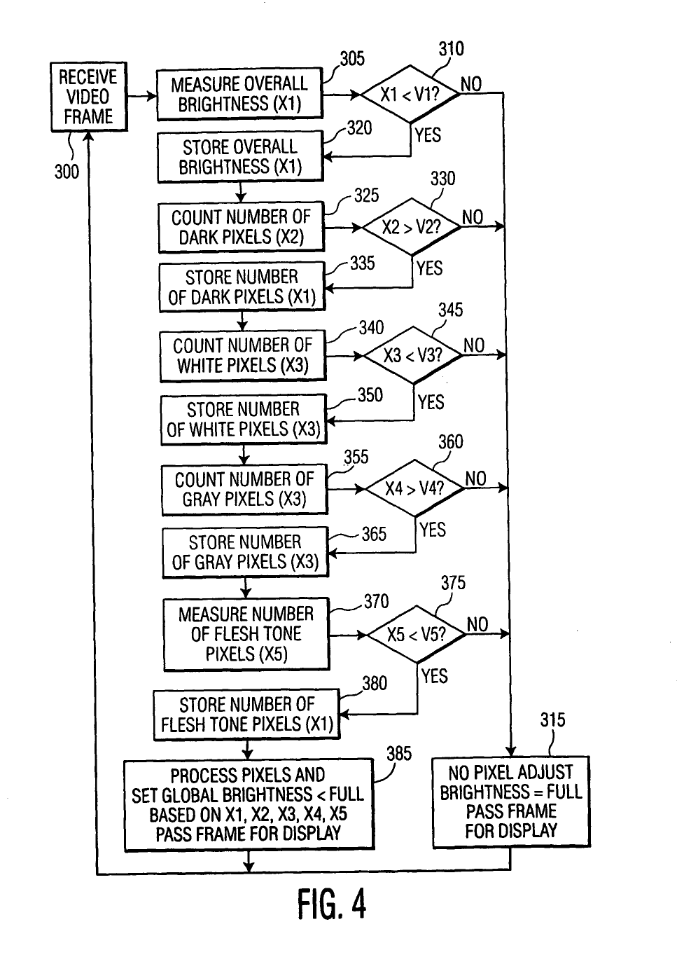

FIG. 3 is a block schematic diagram of the histogram analyzer illustrated in FIG. 2;

FIG. 4 is a flowchart of the operation of the histogram analyzer illustrated in FIG. 2;

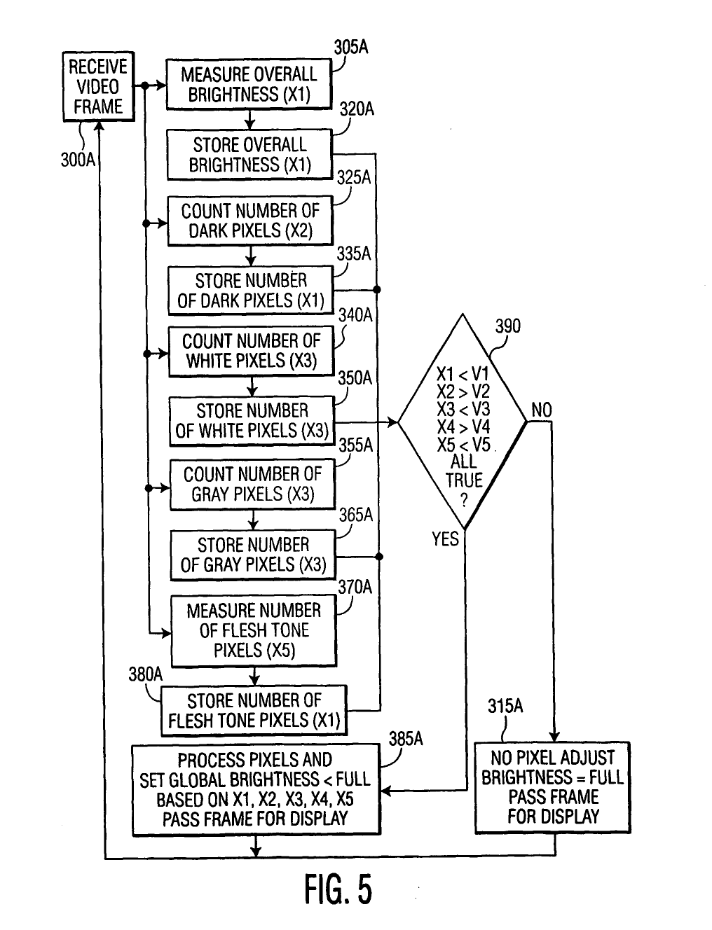

FIG. 5 is a flowchart of an alternative operation of the histogram analyzer illustrated in FIG. 2;

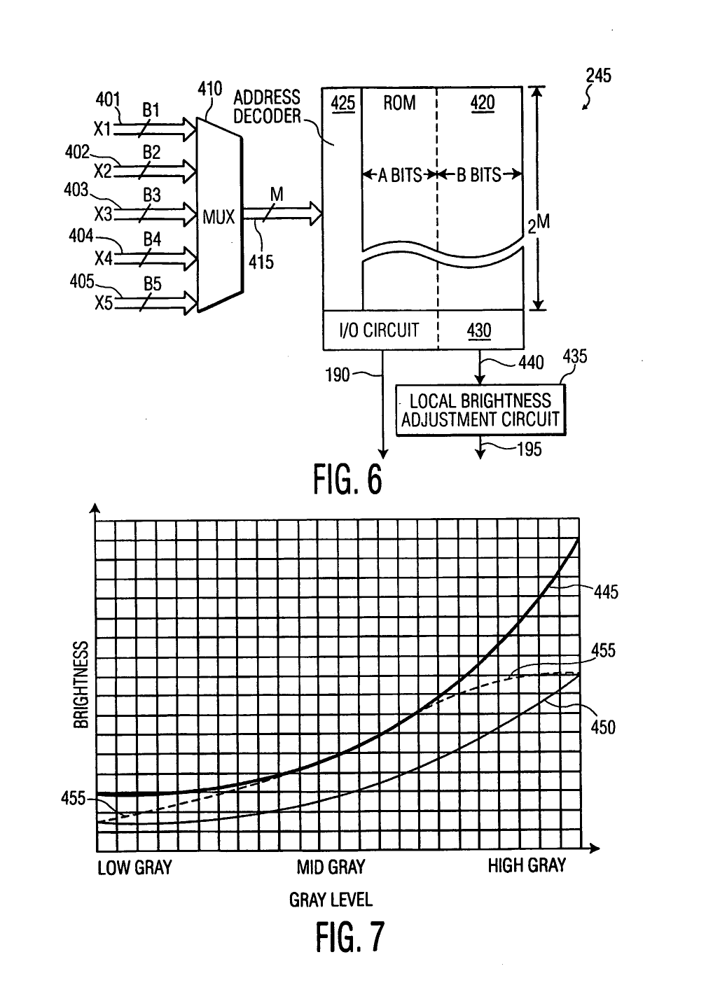

FIG. 6 is diagram illustrating an exemplary implementation of for generating global brightness and local brightness control signals according to the present invention; and

FIG. 7 is graphical representation of the operation of the present invention on an image.

It should be understood the terms subjective, perceived and its various forms as used in the description of the present invention relate to a human observer viewing a video frame as it is projected onto a screen. A gray level is defined as a discrete value on a gray level scale. For example, on a gray level scale of 0 to 255 (256 shades of gray) gray levels (8-bit bus) may have the discrete values 0, 1, 2 through 255.

FIG. 1 is a schematic diagram of an exemplary display system, according to embodiments of the present invention. In FIG. 1, display system 100 includes electronics 105, a light source 110, an optical section 115 and a projection section 120. Light source 110 includes a light bulb 125, a parabolic mirror 130, gratings 135, an adjustable diaphragm 140 and a lens 145. Optical section 115 includes beam splitting mirrors 150, lens 155, three rotatable prisms 160 and a polarizer 165. Projection section 120 includes a reflective display 170, a polarizing beam splitter 175 and a projection lens 180. Reflective display 170 may be an LCD panel such as a liquid crystal on silicon (LCoS) or any other LCD based electro-optical modulating device. Adjustable diaphragm 140 may be replaced with any light-attenuating device such as a transmission LCD or a polarizing twisted nematic cell.

Display system 100 is a single panel scrolling system and is used as an example of a system to which the present invention may be applied. In a single panel scrolling display system three abutting color stripes of red, green and blue (RGB) are produced, each stripe being one-third the height of the reflective display. The stripes are continuously scanned from the top to the bottom of the reflective display synchronously with video signals sent to the reflective display to produce a color image. Other types of systems include single-panel scrolling color transmissive LCD systems, three-panel reflective LCD systems and three-panel transmissive LCD systems.

Electronics 105 receives a video signal 185 and produces a global brightness control signal 190, which is used to control the opening size of adjustable diaphragm which in turn controls the total amount of light available to optical section 115. Global brightness control signal 190 is a global signal because it affects the brightness of all gray levels of pixels in a video frame equally by stopping down (letting less light through) adjustable diaphragm 140. Electronics 105 also produces a local brightness adjusted video signal 195 used to control individual pixels of reflective display 170. Local brightness adjusted video signal 195 is a local signal because it adjusts the brightness of gray levels of pixels in a video frame only in selected ranges of gray levels. Gray level is an attribute of a pixel. Since it is the brightness of gray levels that is adjusted it is not necessary to adjust the brightness of every pixel individually. For example, if the brightness of gray level 27 is adjusted (on a gray level scale of 0 to 255), all those pixels having a gray level of 27 will realize a adjustment in brightness Therefore, it should be understood that adjusting the brightness of a gray level effectively adjusts the brightness of all pixels of that gray level in a video frame.

FIG. 2 is a block schematic diagram of the electronic components of the display system of FIG. 1, according to embodiments the present invention. In FIG. 2, Electronics 105 includes a video signal source receiver 200, an optional analog to digital (A/D) converter 205, a histogram analyzer 210, brightness and color processor 215 and a display panel driver 220.

Video signal source receiver 200 receives video signal 105. The video format may be analog or digital red, green, blue (RGB) format or YUV format (where Y is the luma signal and U and V are the chroma signals). Other variants of video format include RF modulated formats and YcbCr and YIQ variants of YUV formats. If video signal 105 is digital, then a digital video signal 225 is presented directly to histogram analyzer 210. If the video format is not digital, then the signal is processed through A/D converter 205 to produce digital video signal 225. Histogram analyzer 210 receives digital video signal 225. Histogram analyzer 210 generates global brightness control signal 190 and local brightness adjusted video signal 195. Global brightness control signal 190 is coupled to adjustable diaphragm 140 (see FIG. 1). Local brightness adjusted video signal 195 is processed through brightness and color processor 215 and display panel driver 220 before being coupled to display panel 170 (see FIG. 1). Brightness and color processor 215 is operating on a digitalized signal that has already been processed for local gray level brightness adjustment.

FIG. 3 is a block schematic diagram of histogram analyzer 210 illustrated in FIG. 2.

In FIG. 3, histogram analyzer 210 includes a brightness calculator 230, a threshold circuit 235, a flesh tone detector 240 and a decision and brightness adjustment circuit 245. Brightness calculator 230, threshold circuit 235 and flesh tone detector 240 each receive digital video signal 225. Brightness calculator 230, threshold circuit 235 and flesh tone detector 240 each operate on only one (and the same) video frame at a time.

Brightness calculator 230 measures the overall brightness of the video frame. In one example, brightness calculator 230 determines the mean brightness of all pixels in the frame. In a second example, brightness calculator 230 determines the median brightness of all pixels in the frame. Brightness calculator 230 generates an overall brightness signal 251, which is received by decision and brightness adjustment circuit 245.

Threshold circuit 235 measures a number of “dark” pixels, a number of “white” pixels and a number of “gray” pixels and generates a dark number signal 252, a white number signal 253 and a gray number signal 254, which are received by decision and brightness adjustment circuit 245. For a pixel to be counted as a “dark” pixel its brightness must be less than a first pre-determined gray level. For a pixel to be counted as a “white” pixel its brightness must be greater than a second pre-determined gray level. For a pixel to be counted as a “gray” pixel its brightness must be between a lower pre-determined gray level and a higher predetermined gray level. Any single pixel can only be counted in one count (either “dark,” “white” or “gray”), but not all pixels need be counted. In other words, the predetermined gray levels (i.e. first, second lower and higher gray levels) cannot overlap, but they need not abut, there may be that do not fall into any of the specified categories of dark, white or gray pixels.

Flesh tone detector 240 measures a number of pixels that are detected as being flesh tone colors and generates a flesh tone number signal 255, which is received by decision and brightness adjustment circuit 245.

Decision and brightness adjustment circuit 245 then decides whether to adjust the global brightness of the frame and to adjust ranges of gray levels based upon overall brightness signal 251, dark number signal 252, white number signal 253, gray number signal 254 and flesh tone number signal 255 operating upon either a lookup table or a trained circuit. This process is illustrated in FIGS. 4, 5 and 6 and described infra. A global brightness adjustment is always to decrease the overall brightness (stop down adjustable diaphragm 140, see FIG. 1). A local gray level brightness adjustment is always to increase (except for the most black and most white gray levels which are not adjusted) gray level brightness. Both adjustments, however, are performed simultaneously.

FIG. 4 is a flowchart of the operation of the histogram analyzer illustrated in FIG. 2. Experiments have shown that in order to improve the perceived contrast of an image the above five criteria (i.e. overall brightness, number of dark pixels, number of white pixels, number of gray pixels and number of flesh tone pixels) must all be considered and it is best that all criteria be within empirically determined ranges.

In step 300, a video frame is received. In step 305, the overall brightness “X1” of the video frame is determined. In one example, the overall brightness is the mean brightness of all pixels in the frame. In a second example, the overall brightness of the frame is the median brightness of all pixels in the frame. In step 310, the overall brightness “X1” is compared with a predetermined brightness value “V1.” If “X1” is less than “V1” then the method proceeds to step 320. If “X1” is not less than “V1,” then the overall brightness of the frame is high enough for pixel adjustment to not have a perceivable effect on the projected frame and the method proceeds to step 315. Only in images having low brightness and large areas of dark is the effect of dark coloration visible. In high brightness images any improvements made by the present invention are do not change the perceived image significantly enough to warrant processing. In bright images, even if dark areas are present, the human eye adapts to the high overall brightness and does not notice either the low contrast of the original image or a dark areas coloration effect. In step 315, no pixel adjustment is performed, the brightness control signal is left on full, the frame is passed for standard brightness and color processing and the method loops to step 300. In step 320, “X1” is stored.

In step 325, the number of dark pixels “X2,” in the video frame is determined. In one example, a dark pixel is a pixel with a brightness of between 0 and 10% of full-scale brightness. The percentages are determined experimentally. In step 330, the number of dark pixels “X2” is compared with a predetermined value “V2.” If “X2” is greater than “V2” then the method proceeds to step 335. If “X2” is not greater than “V2,” then there are insufficient dark regions in the frame for pixel adjustment to have a perceivable effect on the projected frame and the method proceeds to step 315. As stated supra, only in images having low brightness and large areas of dark is the effect of dark coloration visible. In bright images, even if dark areas are present, the human eye adapts to the high overall brightness and does not notice either the low contrast of the overall image or a dark areas coloration effect. In step 335, “X2” is stored.

In step 340, the number of white pixels “X3,” in the video frame is determined. In one example, a white pixel is a pixel with a brightness of between 90 and 100% of full-scale brightness. The percentages are determined experimentally. In step 345, the number of white pixels “X3” is compared with a predetermined value “V3.” If “X3” is less than “V2” then the method proceeds to step 350. If “X3” is not less than “V3,” then there are enough white regions in the frame for pixel adjustment to not have a perceivable effect on the projected frame and the method proceeds to step 315. If an image having a high number of “white” pixels had its local brightness increased, “white” clipping may occur which is undesirable. In step 350, “X3” is stored.

In step 355, the number of gray pixels “X4,” in the video frame is determined. In one example, a gray pixel is a pixel with a brightness of between 30 and 70% of full-scale brightness. The percentages are determined experimentally. In step 360, the number of gray pixels “X4” is compared with a predetermined value “V4.” If “X4” is greater than “V4” then the method proceeds to step 365. If “X4” is not greater than “V4,” then there are insufficient gray regions in the frame for pixel adjustment to have a perceivable effect on the projected frame and the method proceeds to step 315. Since, only “gray” pixels are the pixels that will be locally brightened, if their number is small, the processed picture will have a much lower overall brightness compared to the original image, which is undesirable. In step 365, “X4” is stored.

In step 370, the number of flesh tone pixels “X5,” in the video frame is determined. Flesh tone pixels may be determined by any number of algorithms know to those of ordinary skill in the art. In step 375, the number of flesh tone pixels “X5” is compared with a predetermined value “V5.” If “X5” is less than “V5” then the method proceeds to step 380. If “X5” is not less than “V5,” then there are enough flesh tone regions in the frame for pixel adjustment to have an adverse perceivable effect on the flesh tone regions of the projected frame and the method proceeds to step 315. If the number of flesh-tone pixels is significant, changing the brightness of the flesh tone pixels results in flesh tones that are not true to life. In step 380, “X5” is stored.

In step 385, based on the values “X1,” “X2,” “X3,” “X4” and “X5,” a global brightness setting is selected or calculated (which may be an adjustable diaphragm setting) constituting global brightness control signal 190 (see FIGS. 1 and 2). Also based on the values “X1,” “X2,” “X3,” “X4” and “X5,” a low-gray level range, a mid-gray level range and a high-gray level range to be brightness adjusted is selected or calculated. Note, not every gray level within the low-gray range and not every gray level within the high gray range is brightness adjusted the same amount. Low-gray levels are brightness boosted progressively the further the gray level is from minimum pixel brightness. High-gray levels are brightness diminished progressively the closer the gray level is to maximum pixel brightness. Mid gray levels are adjusted by the same amount, and that amount is such that the original gray level brightness before global brightness adjustment is restored. This largely preserves the overall brightness of the original frame. The amount of brightness change is a function controlled by the values of “X1,” “X2,” “X3,” “X4” and “X5.” This is illustrated graphically in FIG. 6 and described infra. The gray scale increments to be brightness adjusted and the amount of adjust constitute local brightness adjusted video signal 195 and may be implemented as a increase or decrease in the gain for pixels having gray scale levels within the high or low gray scale ranges. After frame processing is complete, the method loops back to step 300.

While the sequence of decisions illustrated in FIG. 4 are performed sequentially from the comparison of “X1” to “V1” through the comparison of “X5” to “V5,” it should be understood that the comparisons “X1” to “V1,” “X2” to “V2,” “X3” to “V3,” “X4” to “V4” and “X5” to “V5” may be performed in any sequence. Further, while FIG. 4 indicates that all five tests (i.e. “X1”<“V1,” “X2”>“V2,” “X3”<“V3,” “X4”>“V4” and “X5”<“V5”) are performed and must be passed, this is required only for obtaining the best possible improvement in perceived contrast and for lesser improvements in perceived contrast one or more of the test criteria may be eliminated.

FIG. 5 is a flowchart of an alternative operation of the histogram analyzer illustrated in FIG. 2. The method of illustrated in FIG. 5 is essentially the identical method illustrated in FIG. 4 and described supra, except that parallel processing rather than serial processing is performed. Therefore, steps 300A, 305A, 315A, 320A, 325A, 335A, 340A, 350A, 355A, 365A, 370A, 380A and 385A are identical to steps 300, 305, 315, 320, 325, 335, 340, 350, 355, 365, 370, 380 and 385 of FIG. 4. In FIG. 5, after the video frame is received in step 300A it simultaneously processed through steps 305A, 325A, 340A, 355A and 370A and the respective values “X1,” “X2,” “X3,” “X4” and “X5” are stored respectively in steps 320A, 335A, 350A, 365A and 380A as they become available. In step 390 “X1,” “X2,” “X3,” “X4” and “X5” are compared respectively to predetermined values “V1,” “V2,” “V3,” “V4” and “V5” via the five tests X1”<“V1,” “X2”>“V2,” “X3”<“V3,” “X4”>“V4” and “X5”<“V5.” If the results off all five tests are true, then the method loops to step 385A otherwise the method loops to step 315A. Step 300A is repeated after either steps 315A or 385A.

Wile FIG. 5 indicates that all five tests (i.e. “X1”<“V1,” “X2”>“V2,” “X3”<V3,” “X4”>“V4” and “X5”<“V5”) are performed and must be passed, this is only required for obtaining the best possible improvement in perceived contrast and for lesser improvements in perceived contrast one or more of the test criteria may be eliminated.

FIG. 6 is diagram illustrating an exemplary implementation of for generating global brightness and local brightness control signals according to the present invention. In FIG. 5, decision and brightness adjustment circuit includes buses 401,402, 403, 404 and 405, multiplexer 410, a bus 415, a ROM 420 having an address decoder 425 and I/O circuits 430, and a local brightness adjustment circuit 435.

In FIG. 6, the values “X1,” “X2,” “X3,” “X4” and “X5” are driven on to respective buses 401, 402, 403, 404 and 405. The width of each bus 401, 402, 403, 404 and 405 is respectively “B1,” “B2,⇄ “B3,” “B4” and “B5.” In one example, “B1” is 4 bits, “B2” is 2 to 3 bits, “B3” is 2 to 3 bits, “B4” is 3 to 4 bits and “B5” is 2 bits. The signals on buses 401, 402, 403, 404 and 405 are multiplexed together by multiplexer 410 onto bus 415. Bus 410 is at least “M” bits wide, where “M”=the sum of the widths of buses 401, 402, 403, 404 and 405. Continuing the current example, “M” is at least 13 to 16 bits. The multiplexed signal on bus 415 is coupled to row address circuits 425 of read only memory (ROM) 420. ROM 420 has a width of “A” bits+“B” bits and a length of 2^{M} bits. In one example “A”=“B”=4 bits. In the present example, ROM 425 contains 8, 192 to 262, 144 8-bit control words. The “A” and “B” bits represent different possible sets of brightness adjustments o be made to a video frame of using “X1,” “X2,” “X3,” “X4” and “X5” via “M” to select the exact set of brightness adjustments to be applied to the frame. The “A” bits of each control word are used by I/O circuit 435 of ROM 425 to generate global brightness control signal 190 and the “B” bits of each control word are used by I/O circuit 435 are used to generate an internal signal 440. Internal signal 440 is used by local brightness adjustment circuit 435 to generate local brightness adjusted video signal 195. Each word in ROM 420 is determined by experimentation.

Alternatively, a trainable circuit using a learning algorithm based on fuzzy logic or neural networks may be substituted for ROM 420. Typically, 5 selected input criteria and 2 selected output criteria is all such a network requires.

FIG. 7 is graphical representation of the operation of the present invention on an image. Brightness to gray level is mapped. A display device that follows a non-linear power-law gamma characteristic is assumed. Each box horizontally represents a gray scale increment Low-gray gray levels are darker than mid-gray gray levels, which are darker than high-gray gray levels. The lowest low-gray gray level has the least brightness and is closet to pure black. The highest high-gray gray level has the most brightness and is closet to pure white.

In FIG. 7, the gray level of three related video frames is plotted vs. brightness. A gamma value of about 2.2 is assumed for the display device on which the three frames are displayed. Curve 445 represents an original video frame gray level to brightness response. Curve 450 represents a video frame after a global brightness adjustment (decrease) according to the present invention is applied to the original frame represented by curve 445. Curve 455 represents the video frame represented by curve 450 after a local brightness adjustment according to the present invention is applied to the globally brightness adjusted frame represented by curve 450. Curves 445 and 455 overlap one another in the mid-gray gray level region. Note the mid gray levels of the original frame represented by curve 445 are not changed in the transformed video image represented by curve 455.

In effect, the present invention takes the original frame of video represented by curve 445 and performs a non-liner transform to produce a new frame of video represented by curve 455.

Experiments have shown than an increase in brightness, as occurs for low gray pixels in the present invention leads to a perceived loss of color in the displayed image. However, the present invention is equally applicable to color saturation attributes of pixels as well as the gray level attribute and can be used to remedy this situation. For color saturation, the color saturation of mid-gray gray level pixels (or alternatively, all the pixels, regardless of gray level) is increased by an amount proportional to the level of brightness increase of the mid-gray gray levels. Implementation would be by coupling color control circuits of brightness and color processor 215 (see FIG. 1) to internal signal 440 (see FIG. 5).

Therefore, a reflective display system that maintains image contrast while not introducing unwanted coloration has been described. The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

1. A method of processing an image comprising:
measuring a set of pixel dependent attributes for a pixelated video frame, each pixel of said frame having a gray level, each gray level associated with a brightness level; and
in response to each and every pixel dependent attribute of said set of pixel dependent attributes meeting a corresponding criteria, decreasing the overall brightness of said video frame in accordance with a global brightness signal and increasing the brightness of the gray level of each pixel of said video frame in accordance with a local brightness control signal, the amount a particular gray level brightness is increased being dependent upon the particular gray level and a function of said measured pixel dependent attributes.

2. The method of claim 1,
wherein said set of pixel dependent attributes comprises one or more of pixel dependent attributes, each said pixel dependent attribute selected from the group consisting of a first attribute, a second attribute, a third attribute, a fourth attribute and a fifth attribute;
wherein said first attribute is an average or a median brightness of all pixels in said video frame;
wherein said second attribute is a number of dark pixels in said frame, each dark pixel having a value within a first range of gray level values;
wherein said third attribute is a number of white pixels in said frame, each white pixel having a value within a second range of gray level values;
wherein said fourth attribute is a number of gray pixels in said frame, each gray pixel having a value within a third range of gray level values; and
wherein said fifth attribute is a number of flesh tone pixels in said frame.

3. The method of claim 2, wherein said first, second and third ranges of gray level values do not overlap.

4. The method of claim 2,
wherein said criteria corresponding to said first attribute is said average or median brightness of all pixels in said video frame being less than a first value;
wherein said criteria corresponding to said second attribute is said number of dark pixels in said frame being greater than a second value;
wherein said criteria corresponding to said third attribute is said number of white pixels in said frame being less than a third value;
wherein said criteria corresponding to said fourth attribute is said number of gray pixels in said frame being greater than a fourth value; and
wherein said criteria corresponding to said first attribute is said number of flesh tone pixels in said frame being less than a fifth value.

5. The method of claim 2, wherein, the overall brightness of said video frame is decreased by an amount based on empirically generated value corresponding to the determined average or median brightness of said video frames.

6. The method of claim 2, wherein particular gray level brightnesses are increased by an amount based on empirically generated values corresponding to combinations of the number of dark pixels, the number of white pixels, the number of gray pixels and the number of flesh tone pixels in said video frame.

7. The method of claim 1, further including:
increasing a color saturation level of each pixel proportionally to the increase in brightness applied to mid-gray gray levels or proportionally to the global brightness decrease or both.

8. The method of claim 1, wherein the brightness of mid-gray gray levels of pixels of said video frame before said decreasing the overall brightness of said video frame and said increasing the brightness of the gray level of each pixel of said video frame are substantially the same after said decreasing the overall brightness of said video frame and said increasing the brightness of the gray level of each pixel of said video frame.

9. An apparatus for processing an image comprising:
means for measuring a set of pixel dependent attributes on a pixelated video-frame, each pixel of said frame having a gray level, each gray level associated with a brightness level;
means for decreasing the overall brightness of said video frame by an amount in response to each and every pixel dependent attribute of said set pixel dependent attributes meeting a corresponding criteria; and
means for increasing the brightness of the gray level of each pixel of said video frame by different amounts in response to each and every response to each and every pixel dependent attribute of said set pixel dependent attributes meeting a corresponding criteria, the amount a particular gray level brightness is increased being dependent upon the particular gray level and a function of said measured pixel attributes.

10. The apparatus of claim 9, wherein said means for measuring a set of pixel dependent attributes includes one or more means, each means of said one or more means selected from the group consisting of means for determining an average or median brightness of all pixels in said video frame, means for determining a number of dark pixels in said frame, each dark pixel having a value within a first range of gray level values, means for determining a number of white pixels in said frame, each white pixel having a value within a second range of gray level values, means for determining a number of gray pixels in said frame, each gray pixel having a value within a third range of gray level values, and means for determining a number of flesh tone pixels in said frame.

11. The apparatus of claim 10, further including:
means for selecting the amount the overall brightness of said video frame is decreased based on an emperically generated list of values corresponding to the measured average or median brightness.

12. The apparatus of claim 10, further including:
means for selecting the amounts particular gray level brightness's are increased based on an emperically generated list of values corresponding to combinations of the number of dark pixels, the number of white pixels, the number of gray pixels and the number of flesh tone pixels in said video frame.

13. A system for projecting an image onto a display screen comprising:
a light source;
a light-attenuating device for attenuating light emitted from said light source, said light-attenuating device responsive to a global brightness control signal;
a reflective electro-optical modulating device onto to which exit light from said light-attenuating device is projected, said electro-optical modulating responsive to a local brightness adjusted video signal;
means for projecting light reflected from said electro-optical modulating device onto said display screen;
a histogram analyzer adapted to receive a pixelated video frame of said image and to output said global brightness control signal, said global brightness control signal reducing the brightness of every pixel in said frame, adapted to output said local brightness adjusted video signal, said local brightness adjusted video signal increasing selected gray-levels of said pixelated frame and said histogram analyzer adapted to analyze the pixels of said frame, said global brightness control signal and said local brightness adjusted video signal based on said analysis of said pixels.

14. The system of claim 13, wherein said histogram analyzer further includes:
a brightness calculating circuit adapted to determine an average or median brightness of all pixels in said video frame and to generate a brightness signal;
a threshold circuit adapted to determine a number of dark pixels in said frame, each dark pixel having a value within a first range of gray level values, adapted to determine a number of white pixels in said frame, each white pixel having a value within a second range of gray level values, and adapted to determine a number of gray pixels in said frame, each gray pixel having a value within a third range of gray level values; and
a flesh tone circuit adapted to determine a number of flesh tone pixels in said frame.

15. The system of claim 14, further including one or more means, each means selected from the group consisting of means for determining if said brightness signal less than a first value; means for determining if said number of dark pixels is greater than a second value; means for determining if said number of white pixels is less than a third value, means for determining if said number of gray pixels is greater than a fourth value, means for determining if said number of flesh tone pixels is less than a fifth value; and wherein said global brightness control signal and said local brightness adjusted video signal cause changes in the brightness of gray levels of pixels in said frame only if said brightness signal is measured and is less than said first value and said number of dark pixels is measured and is greater than said second value and if said number of white pixels is measured and is less than said third value and said number of gray pixels is measured and is greater than said fourth value and if said number of flesh tone pixels is measured and is less than said fifth value.

16. The system of claim 14, further including a table of control words, a particular control word selectable based on a signal representing a combination of said brightness signal, said number of dark pixels, said number of white pixels, said number of gray pixels and said number of flesh tone pixels, said control words determining said global said global brightness control signal and said local brightness adjusted video signal.

17. The system of claim 16, wherein said control words are empirically generated.

18. The system of claim 13, further including means for increasing the color saturation of mid-gray gray level pixels in proportion to the increase in brightness of mid-gray gray levels.

19. The system of claim 13 wherein said reflective electro-optical modulating device is selected from the group consisting of liquid crystal display devices, liquid crystal on silicon display devices and micro-mirror display devices.

20. The system of claim 13 wherein said light-attenuating device is selected from the group consisting of adjustable diaphragms, transmission liquid crystal display devices and polarizing twisted nematic cells.
